(19) United States
(12) Patent Application Publication
(10) Pub. No.: US 2023/0311150 A1
(43) Pub. Date: Oct. 5, 2023

(54) CLEANING DEVICE AND METHOD OF CLEANING PAINT GUN

(71) Applicant: HONDA MOTOR CO., LTD., Tokyo (JP)

(72) Inventors: Yuta Nagatomo, Tokyo (JP); Wataru Nogita, Tokyo (JP); Yuichi Oda, Tokyo (JP); Kimihide Tabata, Tokyo (JP); Takeshi Nabeta, Tokyo (JP)

(21) Appl. No.: 18/127,029

(22) Filed: Mar. 28, 2023

(30) Foreign Application Priority Data
Mar. 31, 2022 (CN) 202210337543.7

(51) Int. Cl. B05B 15/555; B08B 9/032; B08B 9/023

(52) U.S. Cl. CPC B05B 15/555; B08B 9/0321; B08B 9/023; B08B 2209/032

(57) ABSTRACT

A cleaning device includes a box body, a cleaning nozzle that ejects cleaning liquid toward a paint gun, an air nozzle hole that is configured to eject air toward the paint gun, and an eaves portion that protrudes more toward a central axis line of the insertion hole than the air nozzle hole. A method of cleaning the paint gun includes ejecting cleaning liquid from the cleaning nozzle toward the paint gun. In the ejecting, air is ejected toward the paint gun from the air nozzle hole.

### CROSS-REFERENCE TO RELATED APPLICATIONS

This application is based upon and claims the benefit of priority from Chinese Patent Application No. 202210337543.7 filed on Mar. 31, 2022, the contents of which are incorporated herein by reference.

### BACKGROUND OF THE INVENTION

### Field of the Invention

The present invention relates to a cleaning device and a method of cleaning a paint gun (coating material gun) having a bell-shaped spray head, the device and the method preventing waste liquid from scattering when the paint gun is cleaned.

### Description of the Related Art

A rotary atomizing painting device equipped with a paint gun having a bell type spray head (bell cup) is often used when a workpiece is painted with paint in a painting booth or the like. In the rotary atomizing painting device, the paint atomized by the centrifugal force generated when the bell cup of the paint gun rotates is sprayed onto the workpiece with shaping air.

When the painting color applied to the workpiece is changed, in order to prevent color mixing between the paint before the change and the paint after the change, the paint remaining in the paint gun is washed with a cleaning liquid such as thinner. In order to reuse the cleaning liquid having been used for cleaning, the waste liquid containing the cleaning liquid is recovered using a waste liquid recovery device (see, for example, JP 2009-034635 A).

Inside the waste liquid recovery device, the waste liquid containing the cleaning liquid and the paint is atomized. When the atomized liquid waste (waste liquid mist) rebounds and thus is scattered, it re-attaches to the paint gun. In order to suppress scattering of the atomized waste liquid due to the rebounding, the waste liquid recovery device disclosed in JP 2009-034635 A is provided with an air ejection nozzle above the outer edge of an insertion hole through which the tip of a paint gun is inserted. By blowing air toward the insertion hole, leakage of the waste liquid mist through the gap between the insertion hole and the paint gun is prevented.

### SUMMARY OF THE INVENTION

It is desirable to improve upon the prior art described above and to be able to clean the paint gun better.

An object of the present invention is to solve the above-described problems.

A first aspect of the present invention is a cleaning device that recovers waste liquid generated when a paint gun including a bell-shaped spray head is cleaned, wherein the cleaning device includes: a box body that includes an upper wall being formed with an insertion hole into which a tip portion of the paint gun is inserted; a cleaning nozzle that ejects cleaning liquid toward the tip portion of the paint gun having been inserted into the insertion hole; an air nozzle hole that is provided above an outer edge portion of the insertion hole and configured to eject air toward the tip portion of the paint gun having been inserted into the insertion hole; an eaves portion that is provided below the air nozzle hole and protrudes more toward a central axis line of the insertion hole than the air nozzle hole.

A second aspect of the present invention is a method for cleaning a paint gun including a bell-shaped spray head, the method including an arrangement step of inserting a tip portion of the paint gun into an insertion hole (31) formed in an upper wall (30) of a box body (20); and a cleaning step of ejecting cleaning liquid from a cleaning nozzle (42) toward the tip portion of the paint gun having been inserted into the insertion hole to clean the tip portion, wherein in the cleaning step, air is ejected toward the tip portion of the paint gun from an air nozzle hole (541) provided above an outer edge portion of the insertion hole, and an eaves portion (64) protruding more toward a central axis line of the insertion hole than the air nozzle hole is provided below the air nozzle hole.

According to the present invention, the rebounding of the cleaning liquid can be suppressed by the air ejected from the air nozzle hole. Because the flow velocity of the air flowing in the gap between the insertion hole and the paint gun is increased by the eaves portion, the cleaning liquid adhered to the paint gun can be blown off (undergo air blow) favorably. The gap between the paint gun and the cleaning device is adjusted by the eaves portion, and the paint gun can be air-blown well.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is an overall schematic diagram of a cleaning device according to an embodiment of the present invention.

FIG. 2 is an enlarged view of a principal part of the cleaning device.

FIG. 3 is a plan view of the cleaning device.

### DETAILED DESCRIPTION OF THE INVENTION

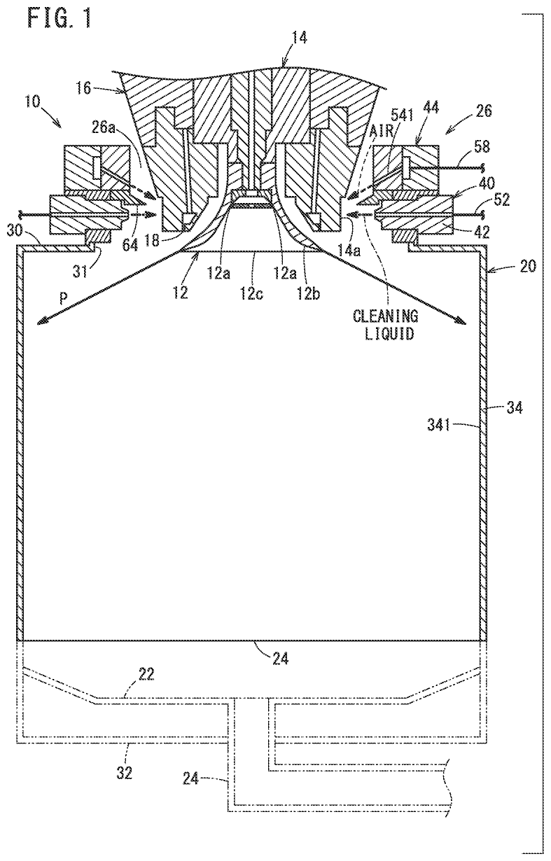

A cleaning device 10 according to the present embodiment shown in FIG. 1 is a device for preventing scattering of waste liquid during cleaning of a paint gun (coating material gun) 14 having a bell-shaped spray head (hereinafter referred to as “bell cup 12”). The waste liquid contains paint (coating material) and cleaning liquid such as thinner. The paint gun 14 includes a bell cup 12 and a body barrel portion 16 for rotatably supporting the bell cup 12 and is attached to the tip of, for example, a robot arm (not shown).

The bell cup 12 has a large number of paint supply holes 12a arranged on the circumference. A shaping air discharge portion 18 is provided behind the bell cup 12 (opposite to the spray direction). The shaping air discharge portion 18 is provided on the tip surface of the body barrel portion 16 and is an outlet from which a high-speed air flow called shaping air is discharged. At the time of painting, the paint is supplied to an inner surface 12b of the bell cup 12 via the large number of paint supply holes 12a. The paint supplied to the inner surface 12b of the bell cup 12 is carried to a cup tip end edge 12c by the centrifugal force generated when the bell cup 12 rotates. The paint is atomized at the cup tip end edge 12c and discharged toward a workpiece (not shown) that is a target to be painted.

The cleaning device 10 includes a box body 20 and a functional unit 26.

In this embodiment, the box body 20 is formed in a cylindrical shape. The outer shape of the box body 20 is not limited to a cylindrical shape, and may be, for example, a truncated cone shape, a rectangular parallelepiped shape, or a truncated pyramid shape. The box body 20 has an upper wall 30 and a side wall 34.

The upper wall 30 is a circular wall connected to the upper end of the side wall 34. The upper wall 30 has an insertion hole 31 for inserting the tip portion of the paint gun 14 (hereinafter also referred to as “gun tip portion 14a”). Because the outer shape of the body barrel portion 16 of the paint gun 14 in a cross section perpendicular to the axis of the body barrel portion 16 is circular, the insertion hole 31 is formed in a circular shape. The insertion hole 31 has a diameter through which at least the shaping air discharge portion 18 of the paint gun 14 can pass.

In this embodiment, the side wall 34 is formed in a hollow cylindrical shape. A discharge portion 24 is formed at the lower end of the side wall 34, and the box body 20 is formed in a cylindrical shape opening downward. The discharge portion 24 can discharge air present inside the box body 20 and discharge waste liquid downward from the box body 20 together with the air. As shown by imaginary lines in the lower part of FIG. 1, the discharge portion 24 may be a hole formed in the bottom wall 32 connected to the lower end of the side wall 34 or a pipe connected to the bottom wall 32, may collect the waste liquid discharged from the discharge portion 24, and may reuse the waste liquid containing the cleaning liquid.

When the waste liquid is collected and reused from the discharge portion 24, the discharge portion 24 is preferably a hole formed in the bottom wall 32 of the box body 20 or a pipe connected to the bottom wall 32. In this case, as shown by imaginary lines in FIG. 1, it is preferable that the waste liquid receiving portion 22 be disposed at the lower portion within the box body 20. Specifically, the waste liquid receiving portion 22 is disposed above the bottom wall 32. The waste liquid receiving portion 22 is formed in a concave shape with a central portion being recessed downward with respect to the outer peripheral portion and receives the waste liquid. The discharge portion 24 is connected to the waste liquid receiving portion 22, and can discharge the waste liquid present in the waste liquid receiving portion 22 and also can discharge air present in the box body 20. The discharge portion 24 is connected to the lowest region of the waste liquid receiving portion 22 so that the waste liquid in the waste liquid receiving portion 22 can be efficiently discharged.

The functional unit 26 is disposed at an upper portion of the box body 20. Specifically, the functional unit 26 is fixed to the upper wall 30 of the box body 20 and protrudes upward from the upper wall 30. The functional unit 26 is formed in an annular shape along the circular insertion hole 31. When the paint gun 14 is cleaned, the gun tip portion 14a is inserted into and disposed in a circular arrangement hole 26a that is a hollow portion of the functional unit 26. The functional unit 26 includes a cleaning mechanism 40 and an air blow mechanism 44.

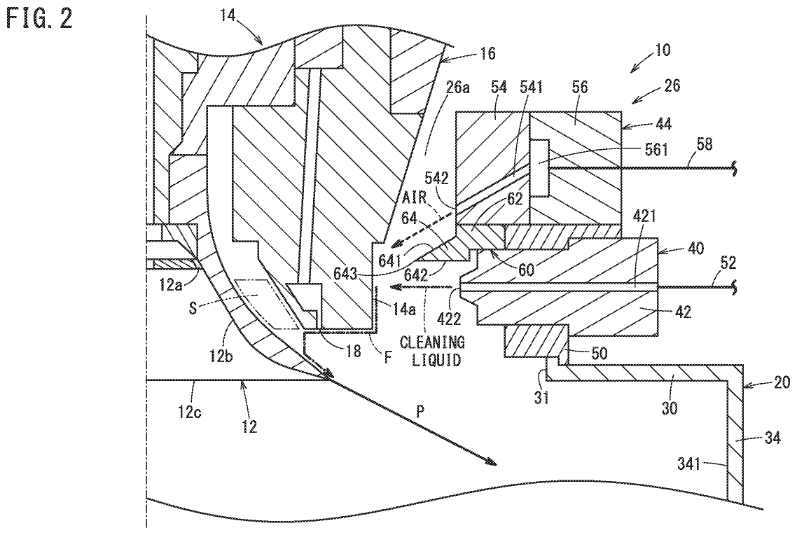

As shown in FIG. 2, the cleaning mechanism 40 has a plurality of cleaning nozzles 42 spaced from each other in the circumferential direction of the functional unit 26. The plurality of cleaning nozzles 42 are mounted on an annular support member 50 fixed to the inner peripheral portion of the upper wall 30 of the box body 20. The plurality of cleaning nozzles 42 are arranged in the vicinity of the insertion hole 31. The cleaning nozzle 42 has a liquid flow path 421 through which cleaning liquid flows and a cleaning liquid discharge port 422 through which the cleaning liquid is discharged. The liquid flow path 421 is connected to a cleaning liquid supply line 52.

The cleaning liquid discharge port 422 is provided at the tip of a cleaning nozzle 42 oriented toward the center of the arrangement hole 26a. The cleaning liquid discharge port 422 discharges (sprays) the cleaning liquid toward the outer peripheral surface of the gun tip portion 14a. The cleaning nozzle 42 is provided horizontally and oriented toward the paint gun 14 (toward the arrangement hole 26a). Specifically, the axis of the cleaning liquid discharge port 422 of the cleaning nozzle 42 runs in the horizontal direction. The axis of the cleaning liquid discharge port 422 may slope downward toward the arrangement hole 26a.

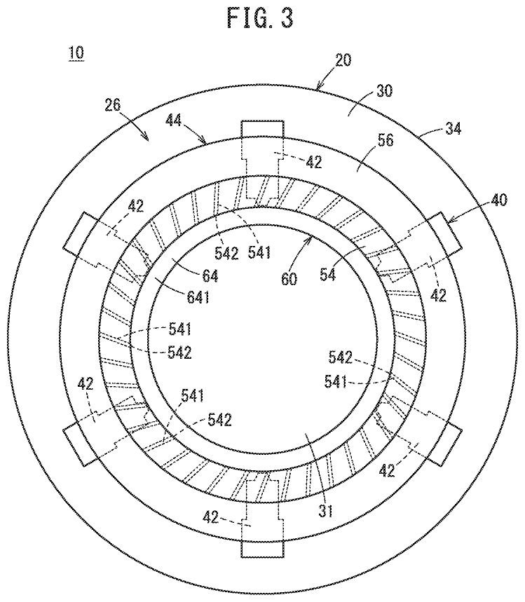

As shown in FIG. 3, the cleaning nozzles 42 are arranged at equal angular intervals in the circumferential direction around the insertion hole 31. In the present embodiment, six cleaning nozzles 42 are arranged at equal angular intervals. The number of cleaning nozzles 42 may be five or less, or seven or more instead.

As shown in FIG. 1, in the present embodiment, the cleaning nozzles 42 are disposed near the outer edge of the insertion hole 31 at the upper portion of the box body 20, but the arrangement of the cleaning nozzles 42 is not limited to this example. The cleaning nozzle 42 only needs to be capable of ejecting cleaning liquid inside the box body 20 toward the tip portion of the paint gun 14 inserted into the insertion hole 31. For this reason, the cleaning nozzle 42 may be provided at the lower portion inside the box body 20 or at an intermediate height between the lower portion and the upper portion inside the box body 20.

The air blow mechanism 44 is disposed above the cleaning mechanism 40. As shown in FIG. 3, the air blow mechanism 44 includes an annular nozzle block 54 having a plurality of air nozzle holes 541, and an annular air supply block 56 surrounding the nozzle block 54. The plurality of air nozzle holes 541 are formed at intervals in the circumferential direction of the outer edge portion of the insertion hole 31. The plurality of air nozzle holes 541 are provided so as to be at an angle with respect to the radial direction of the insertion hole 31 when viewed from the axial direction of the insertion hole 31. The plurality of air nozzle holes 541 may be provided in the radial direction of the insertion hole 31 when viewed from the axial direction of the insertion hole 31.

As shown in FIG. 2, the inner end of the air nozzle hole 541 is an air discharge port 542 opened on the inner peripheral surface of the nozzle block 54. The air nozzle hole 541 is provided so as to slope downward toward the air discharge port 542. In other words, each air nozzle hole 541 slopes downward toward the inner peripheral surface of the nozzle block 54.

The air supply block 56 has an annular air flow path 561 surrounding the nozzle block 54. The air flow path 561 is connected to an air supply line 58. Air supplied from the air supply line 58 to the air flow path 561 flows in the air flow path 561 in the circumferential direction and flows into the plurality of air nozzle holes 541. Air is discharged from the air discharge port 542 of the plurality of air nozzle holes 541 toward the arrangement hole 26a.

The functional unit 26 further includes an eaves ring member 60. The eaves ring member 60 is disposed between the cleaning nozzle 42 and the nozzle block 54. The eaves ring member 60 is formed in an annular shape surrounding the arrangement hole 26a. The eaves ring member 60 has an outer peripheral base portion 62 constituting the outer peripheral portion of the eaves ring member 60, and an eaves portion 64 protruding radially inward from the inner periphery of the outer peripheral base portion 62.

The eaves portion 64 is provided below the air nozzle hole 541 and protrudes more toward the central axis of the insertion hole 31 than the air nozzle hole 541. The eaves portion 64 is provided between the cleaning nozzle 42 and the air nozzle hole 541. More specifically, the eaves portion 64 is disposed at a height between the air discharge port 542 and the cleaning liquid discharge port 422.

An upper surface 641 (inner surface) of the eaves portion 64 is formed in a tapered shape along the tilt of the air nozzle hole 541. Therefore, the upper surface 641 of the eaves portion 64 and the axis of the air nozzle hole 541 are substantially parallel to each other. The lower surface 642 of the eaves portion 64 is a horizontal plane parallel to the axis of the cleaning liquid discharge port 422 of the cleaning nozzle 42. In the radial direction of the insertion hole 31, an inner peripheral end 643 of the eaves portion 64 is positioned further inward than the cleaning liquid discharge port 422 of the cleaning nozzle 42. As shown in FIG. 3, the eaves portion 64 is formed in an annular shape extending over the entire circumference along the outer edge of the insertion hole 31. The eaves portion 64 is formed to be concentric with the insertion hole 31. An upper surface 641 of the eaves portion 64 is an annular tapered surface the diameter of which decreases downward.

A method of cleaning the paint gun 14 using the cleaning device 10 is performed as below.

For example, when a paint color applied on a workpiece is changed or when regular cleaning operations are performed, the paint gun 14 is cleaned. The cleaning method includes an arrangement step of arranging the paint gun 14 at a predetermined position and a cleaning step of cleaning the paint gun 14.

First, the arrangement step is performed. As shown in FIG. 1, in the arrangement step, the tip portion (gun tip portion 14a) of the paint gun 14 is inserted into the insertion hole 31 formed in the upper wall 30 of the box body 20. Specifically, for example, the robot arm are moved, whereby the gun tip portion 14a attached to the tip of the robot arm is inserted into the insertion hole 31 via the arrangement hole 26a of the functional unit 26. As a result, the gun tip portion 14a is disposed on the inner side of the functional unit 26 (the arrangement hole 26a). At this time, the plurality of cleaning nozzles 42 and the air discharge ports 542 of the plurality of air nozzle holes 541 face the outer peripheral surface of the gun tip portion 14a.

Next, the cleaning step is performed. The cleaning step includes an internal cleaning step for cleaning the internal flow path of the paint gun 14 and an external cleaning step for cleaning the outer peripheral surface of the gun tip portion 14a. In the internal cleaning step, the cleaning liquid is supplied to the internal flow path of the paint gun 14 while the bell cup 12 is rotated, and the shaping air is discharged from the shaping air discharge portion 18 to spray the waste liquid. The waste liquid is liquid that contains paint and cleaning liquid remaining in the internal flow path of the paint gun 14. The waste liquid atomized at the cup tip end edge 12c by the shaping air forms a spray pattern P expanding downward and is sprayed from the cup tip end edge 12c.

The external cleaning step is performed after the internal cleaning step or in parallel with the internal cleaning step. As shown in FIG. 2, in the external cleaning step, the cleaning liquid is supplied from the cleaning liquid supply line 52 to the liquid flow path 421 of the cleaning nozzle 42, and the cleaning liquid is ejected toward the outer peripheral surface of the gun tip portion 14a from the cleaning liquid discharge port 422. Thus, the paint adhered to the outer peripheral surface of the gun tip portion 14a is washed away by the cleaning liquid.

In the cleaning process, air is supplied to the plurality of air nozzle holes 541 of the air blow mechanism 44, and air is discharged from the air discharge port 542 toward the arrangement hole 26a. Air is introduced into the internal space of the box body 20 via the arrangement hole 26a (specifically, between the inner peripheral portion of the functional unit 26 and the outer peripheral portion of the paint gun 14) and the insertion hole 31. Thus, in the internal cleaning step, it is suppressed that the atomized waste liquid moves upward via the insertion hole 31 and the arrangement hole 26a and comes out of the cleaning device 10. In the external cleaning step, upward rebounding of the cleaning liquid that has collided with the outer peripheral surface of the gun tip portion 14a is suppressed, and the cleaning liquid is suppressed from coming out of the cleaning device 10 via the arrangement hole 26a (scattering). In the external cleaning process, the cleaning liquid adhering to the gun tip portion 14a is blown downward (air-blown) by the air discharged from the air blow mechanism 44.

Further, the cleaning method may include a discharging step of discharging the waste liquid present inside the box body 20. The discharging step is performed after the cleaning step or during the cleaning step. In the discharge step, the waste liquid received at the lower portion of the box body 20 is recovered. Specifically, the waste liquid generated in the cleaning step is received by the waste liquid receiving portion 22 shown in FIG. 1 and then sent from the waste liquid receiving portion 22 to the outside of the box body 20 via the discharge portion 24 and collected.

The present embodiment provides the following effects.

As shown in FIG. 2, the cleaning device 10 includes the cleaning nozzle 42 that ejects the cleaning liquid toward the tip portion of the paint gun 14, the air nozzle hole 541 that ejects air toward the tip portion of the paint gun 14, and an eaves portion 64 that is provided below the air nozzle hole 541. With this configuration, it is possible to suppress the rebounding of the cleaning liquid by means of the air ejected from the air nozzle hole 541. Because the flow velocity of the air flowing in the gap between the insertion hole 31 and the paint gun 14 is increased by the eaves portion 64, the cleaning liquid adhered to the paint gun 14 can be blown off (undergo air blow) favorably. The gap between the paint gun 14 and the cleaning device 10 (insertion hole 31) can be adjusted by the eaves portion 64, and the paint gun 14 can be air-blown well.

A plurality of air nozzle holes 541 are arranged in the circumferential direction of the outer edge of the insertion hole 31. An air curtain is formed in the gap between the paint gun 14 and the insertion hole 31 by a plurality of air nozzle holes 541, so that the rebounding of the cleaning liquid can be suppressed.

Because the plurality of air nozzle holes 541 are provided so as to be at an angle with respect to the radial direction of the insertion hole 31 when viewed from the axial direction of the insertion hole 31 (see FIG. 3), the air curtain can be formed and the scattering of the cleaning liquid can be suppressed. Further, because a swirling flow is formed by the air discharged from the plurality of air nozzle holes 541 arranged as described above, the paint gun 14 can be air-blown favorably.

The cleaning nozzle 42 is provided near the insertion hole 31, and the eaves portion 64 is provided between the cleaning nozzle 42 and the air nozzle hole 541. Since the eaves portion 64 is disposed between the cleaning nozzle 42 and the air nozzle hole 541, a good balance can be achieved between the suppression of the rebounding of the cleaning liquid and the air blowing of the paint gun 14 by means of the air coming out of the air nozzle hole 541.

The air nozzle hole 541 is provided so as to slope downward toward the air discharge port 542 of the air nozzle hole 541, and the upper surface 641 of the eaves portion 64 is formed in a tapered shape along the tilt of the air nozzle hole 541. Since the air nozzle hole 541 is provided so as to be slope downward, the cleaning liquid adhered to the paint gun 14 can be air-blown more favorably toward the discharge portion 24.

Since the cleaning nozzle 42 is provided horizontally toward the paint gun 14, during cleaning, the cleaning liquid ejected from the cleaning nozzle 42 toward the paint gun 14 flows as indicated by the arrow F along the outer surface shape of the paint gun 14. Accordingly, it is possible to prevent the cleaning liquid from entering into a region S of the paint gun 14 where cleaning is unnecessary, and it is possible to perform the air blow well with the cleaning nozzle 42. Since the penetration of the cleaning liquid into the region S where cleaning is unnecessary is suppressed, it is possible to prevent liquid from dripping down after the cleaning. As shown in FIG. 2, a gap in the radial direction between the inner peripheral surface of the tip portion of the body barrel portion 16 and the outer peripheral surface of the bell cup 12 is the region S in which the cleaning is unnecessary.

As shown in FIG. 1, the cleaning device 10 includes a discharge portion 24 capable of discharging air present inside the box body 20. Since the air is discharged from the discharge portion 24, a flow of the air is formed inside the box body 20 so that the air can be blown favorably to the paint gun 14.

The discharge portion 24 is provided at the lower portion of the box body 20 and discharges waste liquid from the inside of the box body 20. Since the discharge portion 24 discharges air and waste liquid, the cleaning device 10 can be simplified.

After the paint gun 14 is cleaned, a confirmation operation (so-called test spraying) of spraying the paint from the paint gun 14 may be performed while the gun tip portion 14a is in the insertion hole 31. At the time of test spraying, air may be discharged from the air blow mechanism 44. Air discharged from the air blow mechanism 44 generates an air flow from the insertion hole 31 toward the inside of the box body 20, so that during test spraying, it is possible to suppress leakage of atomized waste liquid (in this case, atomized paint) from between the insertion hole 31 and the paint gun 14 to the outside of the cleaning device 10.

The above-described embodiments are summarized as follows.

Disclosed is a cleaning device (10) that recovers waste liquid generated when a paint gun (14) including a bell-shaped spray head (12) is cleaned, wherein the cleaning device (10) includes: a box body (20) that includes an upper wall (30) being formed with an insertion hole (31) into which a tip portion of the paint gun is inserted; a cleaning nozzle (42) that ejects cleaning liquid toward the tip portion of the paint gun having been inserted into the insertion hole; an air nozzle hole (541) that is provided above an outer edge portion of the insertion hole and configured to eject air toward the tip portion of the paint gun having been inserted into the insertion hole; an eaves portion (64) that is provided below the air nozzle hole and protrudes more toward a central axis line of the insertion hole than the air nozzle hole.

The cleaning device includes a discharge portion (24) that is provided in the box body and configured to discharge air present inside the box body.

The discharge portion is provided at a lower portion of the box body and discharges the waste liquid from inside the box body.

The cleaning device includes a plurality of air nozzle holes including the air nozzle hole wherein the plurality of air nozzle holes are arranged in the circumferential direction of the outer edge portion of the insertion hole.

The plurality of air nozzle holes are inclined with respect to a radial direction of the insertion hole when viewed from an axial direction of the insertion hole.

The cleaning nozzle is provided in the vicinity of the insertion hole, and the eaves portion is provided between the cleaning nozzle and the air nozzle hole.

The air nozzle hole is provided so as to be inclined downward toward an air discharge port (542) of the air nozzle hole, and an upper surface (641) of the eaves portion is formed in a tapered shape along an inclination of the air nozzle hole.

The cleaning nozzle is provided horizontally facing toward the paint gun.

Disclosed is a method of cleaning a paint gun (14) including a bell-shaped spray head (12), the method including: inserting a tip portion of the paint gun into an insertion hole (31) formed in an upper wall (30) of a box body (20); and ejecting cleaning liquid from a cleaning nozzle (42) toward a tip portion of the paint gun having been inserted into the insertion hole to clean the tip portion, wherein in the ejecting, air is ejected toward the tip portion of the paint gun from an air nozzle hole (541) provided above an outer edge portion of the insertion hole, and an eaves portion (64) protruding more toward a central axis line of the insertion hole than the air nozzle hole is provided below the air nozzle hole.

It should be noted that the present invention is not limited to the above-described embodiment, and various configurations can be adopted without departing from the gist of the present invention.

What is claimed is:

1. A cleaning device that recovers waste liquid generated when a paint gun including a bell-shaped spray head is cleaned, wherein the cleaning device comprises:
a box body that includes an upper wall being formed with an insertion hole into which a tip portion of the paint gun is inserted;
a cleaning nozzle that ejects cleaning liquid toward the tip portion of the paint gun having been inserted into the insertion hole;
an air nozzle hole that is provided above an outer edge portion of the insertion hole and configured to eject air toward the tip portion of the paint gun having been inserted into the insertion hole;
an eaves portion that is provided below the air nozzle hole and protrudes more toward a central axis line of the insertion hole than the air nozzle hole.

2. The cleaning device according to claim 1, further comprising
a discharge portion that is provided in the box body and configured to discharge air present inside the box body.

3. The cleaning device according to claim 2, wherein
the discharge portion is provided at a lower portion of the box body and discharges the waste liquid from inside the box body.

4. The cleaning device according to claim 1, further comprising
a plurality of air nozzle holes including the air nozzle hole,
wherein the plurality of air nozzle holes are arranged in a circumferential direction of the outer edge portion of the insertion hole.

5. The cleaning device according to claim 4, wherein
the plurality of air nozzle holes are inclined with respect to a radial direction of the insertion hole when viewed from an axial direction of the insertion hole.

6. The cleaning device according to claim 1, wherein
the cleaning nozzle is provided in a vicinity of the insertion hole, and
the eaves portion is provided between the cleaning nozzle and the air nozzle hole.

7. The cleaning device according to claim 1, wherein
the air nozzle hole is provided so as to be inclined downward toward an air discharge port of the air nozzle hole, and
an upper surface of the eaves portion is formed in a tapered shape along an inclination of the air nozzle hole.

8. The cleaning device according to claim 7, wherein
the cleaning nozzle is provided horizontally facing toward the paint gun.

9. A method of cleaning a paint gun including a bell-shaped spray head, the method comprising:
inserting a tip portion of the paint gun into an insertion hole formed in an upper wall of a box body; and
ejecting cleaning liquid from a cleaning nozzle toward the tip portion of the paint gun having been inserted into the insertion hole to clean the tip portion,
wherein in the ejecting, air is ejected toward the tip portion of the paint gun from an air nozzle hole provided above an outer edge portion of the insertion hole, and
an eaves portion protruding more toward a central axis line of the insertion hole than the air nozzle hole is provided below the air nozzle hole.
